(19) United States
(12) Patent Application Publication
(10) Pub. No.: US 2016/0247470 A1
(43) Pub. Date: Aug. 25, 2016

(54) DRIVING CIRCUIT OF DISPLAY PANEL AND METHOD FOR DRIVING THE DISPLAY PANEL

(71) Applicant: SHENZHEN CHINA STAR OPTOELECTRONICS TECHNOLOGY CO. LTD., Shenzhen (CN)

(72) Inventor: Xiaoping TAN, Shenzhen (CN)

(21) Appl. No.: 14/232,905

(22) PCT Filed: Dec. 11, 2013
(86) PCT No.: PCT/CN2013/089102

§ 371 Date: Jan. 15, 2014

(30) Foreign Application Priority Data
Nov. 27, 2013 (CN) 201310612914.9

(51) Int. Cl. G09G 3/36

(52) U.S. Cl. CPC G09G 3/3648; G09G 2320/0223; G09G 2310/08

(57) ABSTRACT

A method for driving a display panel comprises: driving scan lines of the display panel row by row. In a time period of displaying one frame, a driving time of at least one row of the scan lines is greater than a driving time of a first row of the scan lines, and a sum of driving times of all scan lines is less than or equal to display time of a single frame picture.

### TECHNICAL FIELD

The present disclosure relates to the field of liquid crystal displays (LCDs), and more particularly to a driving circuit of a display panel and a method for driving the display panel.

### BACKGROUND

As resolution and size of liquid crystal display (LCD) devices increase, an equivalent resistive load and an equivalent capacitive load using an equivalent transmission method corresponding to a panel increases when the panel is driven by a thin film transistor (TFT). As shown in FIG. 1, when a scan signal of a first row of scan lines is sent, a data driving integrated circuit outputs a data signal (a waveform of the data signal is shown in FIG. 2). However, in such a case, the waveform of the data signal in an n-th row of scan lines is changed (the changed waveform is shown in FIG. 3). The change of the waveform of the data signal is called a resistor capacitor (RC) delay. Thus, different vertical positions of one data line have different charging effects, and when charging difference between different vertical positions of the one data line is great, differences of alignment among an upper area, a middle area, and a lower area of the panel increases, thereby reducing image quality of the panel.

### SUMMARY

The aim of the present disclosure is to provide a driving circuit of a display panel and a method for driving the display panel capable of reducing alignment degree differences between different areas of the display panel.

The aim of the present disclosure is achieved by the following methods.

A method for driving a display panel comprise: driving scan lines of the display panel row by row. In a time period of displaying one frame, a driving time of at least one row of the scan lines is greater than a driving time of a first row of the scan lines, and a sum of driving times of all scan lines is less than or equal to display time of single frame picture.

Furthermore, the driving time of the first row of scan lines is regarded as T, a number of the scan lines is regarded as N, a vertical blanking time between two adjacent frame pictures is regarded as Tl, and the sum of driving times of all scan lines is regarded as Tm, thus, a difference value between Tm and T*N is less than or equal to Tl. It should be understood that the vertical blanking time exists in a time of switching two adjacent frame pictures, and image display of the display panel is not generated in the vertical blanking time. In the present disclosure, the vertical blanking time is a part of the display time of signal frame picture. As long as a sum of the added times of all scan lines is less than or equal to the vertical blanking time, the normal image display is not affected. In the present disclosure, the charge time of the scan lines is increased, which improves the charge amount of the pixel and increases alignment degree.

Furthermore, in the time period of displaying one frame, a driving time of a next row of the scan lines is greater than a driving time of a previous row of the scan lines.

Furthermore, in the time period of displaying one frame, a difference value between the driving times of two adjacent rows of scan lines is the same, which simplifies product design.

Furthermore, in the time period of displaying one frame, a difference value between the driving times of two adjacent rows of scan lines gradually increases, which achieves better alignment degree. With an increase of a length of the data line, in a condition of the RC delay, the waveform change of the data driving signal of the data line is not linear, but is gradually increased. Thus, the driving time of the scan lines can be accordingly increased, which compensates the waveform change of the data driving signal of the data line better, thereby improving display quality.

Furthermore, the scan lines are divided into a plurality of groups, the scan lines of each of the groups comprises at least one row of scan lines, and a driving time of a next group of scan lines is greater than a driving time of a previous group of next scan lines, which simplifies the control the scan lines, and reduces development and manufacturing costs.

Furthermore, the driving times of the scan lines in each of the groups are the same.

Furthermore, in the time period of displaying one frame, a difference value between the driving times of two adjacent groups of the scan lines is the same.

A driving circuit of a display panel comprises scan lines and a time block that controls a driving sequence of the scan lines, the scan lines are connected to the time block, and the time block drives the scan lines row by row. In a time period of displaying one frame, a driving time of at least one row of scan lines is greater than a driving time of a first row of scan lines, and a sum of driving times of all scan lines is less than or equal to display time of single frame picture.

The driving time of the first row of scan lines is regarded as T, a number of the scan lines is regarded is N, a vertical blanking time between two adjacent frame pictures is regarded as Tl, and the sum of driving times of all scan lines is regarded as Tm, thus, a difference value between Tm and T*N is less than or equal to Tl.

Furthermore, the driving circuit of the display panel further comprises a scan line driving circuit connected to the scan lines. The time block comprises a timing schedule controller coupled to the scan line driving circuit, and a storage unit coupled to the timing schedule controller. The timing schedule controller reads a driving time of each row of scan lines from the storage unit to generate a driving signal, and sends the driving signal to the scan line driving circuit.

Furthermore, the driving circuit of the display panel further comprises a scan line driving circuit connected to the scan lines. The time block comprises a timing schedule controller and a storage unit, and the timing schedule controller comprises a driving unit that increases the driving time of the scan lines row by row. The driving unit reads a difference value between the driving times of two adjacent rows of scan lines from the storage unit to generate a driving signal, and sends the driving signal to the scan line driving circuit.

The driving time of each of the scan lines is the same in prior art. As transmission distance of data driving signals increases, a charge amount of a pixel decreases in a same driving time of the scan lines, which causes alignment degree difference between different areas of the display panel. The present disclosure uses a method of increasing the driving time of the scan lines to improve a charge time of a data line, and compensates charge amount difference caused by a waveform change of data driving signals due to a resistor capacitor (RC) delay, thereby achieving even brightness, and improving the alignment degree and image quality of the display panel. As long as the sum of driving times of all scan lines is less than or equal to the display time of single frame picture, a normal image display cannot be affected. In the present disclosure, a typical data driving signal is not changed, and only the driving sequence of the scan lines is adjusted, where adjustment of the driving sequence of the scan lines is easier than change of the data driving signal, thereby shortening development cycle of the product and reducing development difficulty.

### BRIEF DESCRIPTION OF FIGURES

FIG. 1 is a schematic diagram of a circuit of a typical display panel.

FIG. 2 is a waveform diagram of driving a first row of the scan lines of a typical display panel.

FIG. 3 is a waveform diagram of driving an n-th row of the scan lines of a typical display panel.

FIG. 4 is a flowchart of a method for driving a display panel of an example of the present disclosure.

FIG. 5 is a waveform diagram of driving a scan line of a driving circuit of a display panel of an example of the present disclosure.

FIG. 6 is a schematic diagram of a driving circuit of a display panel of an example of the present disclosure.

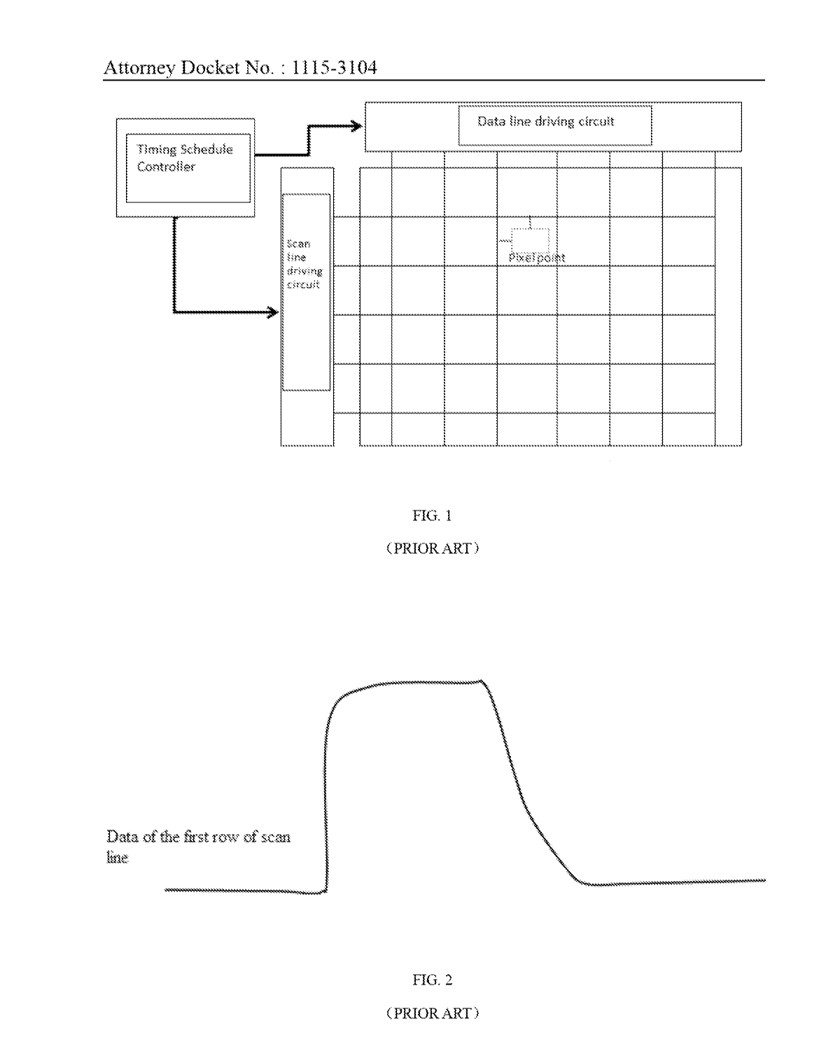

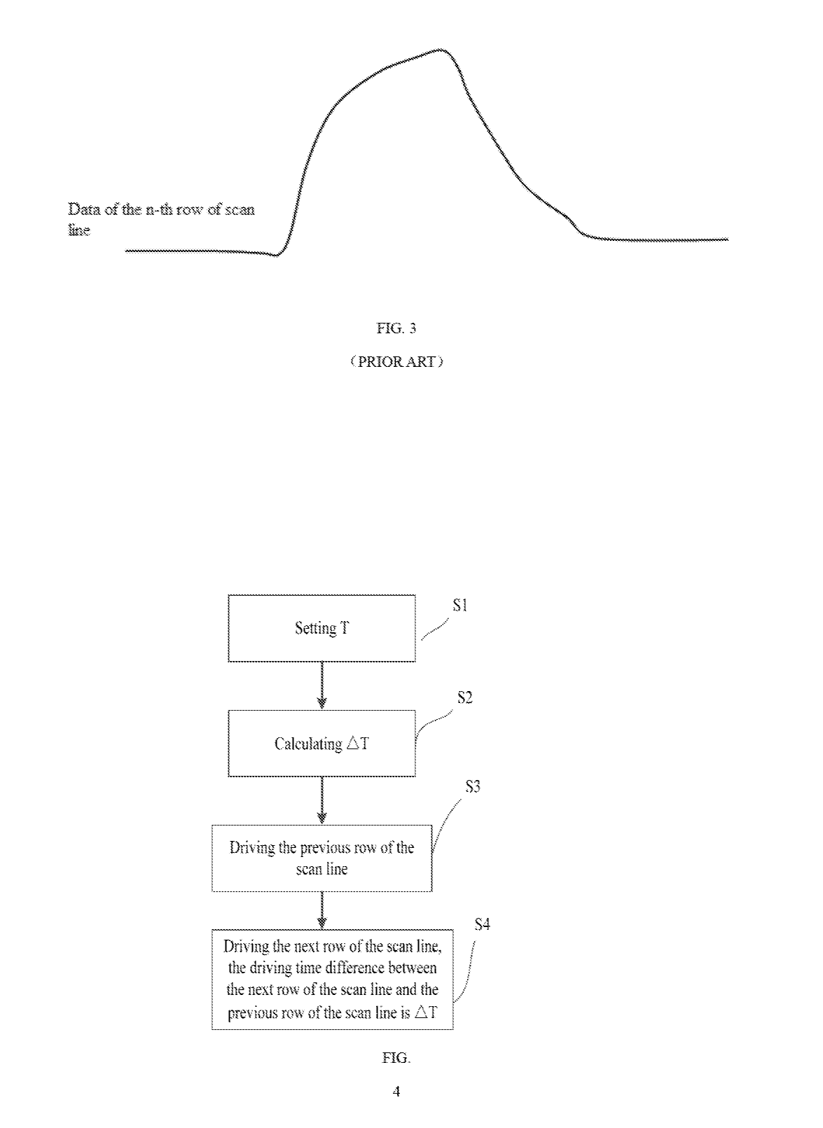

### DETAILED DESCRIPTION

The present disclosure provides a driving circuit of a display panel and a method for driving the display panel. The driving circuit of the display panel comprises a plurality of scan lines, and the scan lines are connected to a time block that controls a driving sequence of the scan lines. The time block drives the scan lines of the display panel row by row. In a time period of displaying one frame, a driving time of at least one row of scan lines is greater than a driving time of a first row of scan lines, and a sum of driving times of all scan lines is less than or equal to display time of single frame picture.

A driving time of each of the scan lines is the same as in the prior arts. As transmission distance of data driving signals increases, charge amount of a pixel decreases in a same driving time of the scan lines, which causes alignment degrees to be different between different areas of the display panel. The present disclosure increases the driving time of the scan lines to improve charge time of a data line, and compensates for charge amount differences caused by a waveform change of the data driving signal due to a resistor capacitor (RC) delay, thereby achieving even brightness, and improving alignment degree and image quality of the display panel. As long as the sum of driving times of all scan lines is less than or equal to the display time of single frame picture, a normal image display cannot be affected. In the present disclosure, a typical data driving signal is not changed, and only the driving sequence of the scan lines is adjusted, where adjustment of the driving sequence of the scan lines is easier than change of the data driving signal, thereby shortening development cycle of the product and reducing development difficulty.

The present disclosure will further be described in detail in accordance with the figures and the exemplary examples.

### Example 1

As shown in FIG. 4, a first example provides a method for driving the display panel comprising:

S1: setting the driving time T of the first row of scan lines;

S2: calculating an added value ΔT of the driving time of each of the scan lines according to a vertical blanking time Tl between two adjacent frame pictures and a total number N of the scan lines;

S3: driving the scan lines of the display panel row by row, and driving a previous row of the scan lines;

S4: driving a next row of the scan lines, where in the time period of displaying one frame, the driving time of the next row of the scan lines is greater than the driving time of the previous row of the scan lines, and a driving time difference of two adjacent rows of scan lines is ΔT;

The driving time of the first row of scan lines is regarded as T, a number of the scan lines is regarded as N, the vertical blanking time between two adjacent flame pictures is regarded as Tl, and the sum of driving times of all scan lines is regarded as Tm, thus, a difference value between Tm and T*N is less than or equal to Tl.

It should be understood that the vertical blanking time exists in a time of switching two adjacent flame pictures, and image display of the display panel is not generated in the vertical blanking time. In the present disclosure, the vertical blanking time is a part of the display time of signal frame picture. As long as a sum of the added times of all scan lines is less than or equal to the vertical blanking time, the normal image display is not affected. In the present disclosure, the charge time of the scan lines is increased, which improves the charge amount of the pixel and increases alignment degree.

Taking a resolution of 1920*1080 (horizontal display pixel*vertical display pixel), horizontal total pixel of 2200, vertical total pixel of 1125, scan frequency of 60 HZ for example, the vertical blanking time is about 0.7 ms, and a scanning time of each of the scan lines is about 14.8 us. The scanning time of each of the scan lines is gradually adjusted from a reference value by a method until the scanning time of the scan lines achieves a maximum time allowed. As shown in FIG. 5, the scanning time of the first scan lines is 14.2 us, and the scanning time of the scan lines is 14.8 us after scanning about one thousand and eighty rows of the scan lines, at this time, the charge time of one frame is end, then the first row of the scan lines is rescanned. The above mentioned scanning method is repeated, which allows the charge amount of all areas of the display panel to be consistent.

To further simplify a control of the scan lines, the scan lines are divided into a plurality of groups, and the scan lines in a same group are controlled together. The scan lines of each of the groups comprises at least one scan line, a driving time of the scan lines of a next group is greater than a driving time of the scan lines of a previous group, the driving times of the scan lines in each of the groups are the same, and a difference value between the driving times of two adjacent groups of the scan lines is the same.

With an increase of a length of the data line, and because of the RC delay, the waveform change of the data driving signal of the data line is not linear, but is gradually increased. Thus, the driving time of the scan lines can be accordingly increased, which compensates the waveform change of the data driving signal of the data line better, thereby improving display quality.

### Example 2

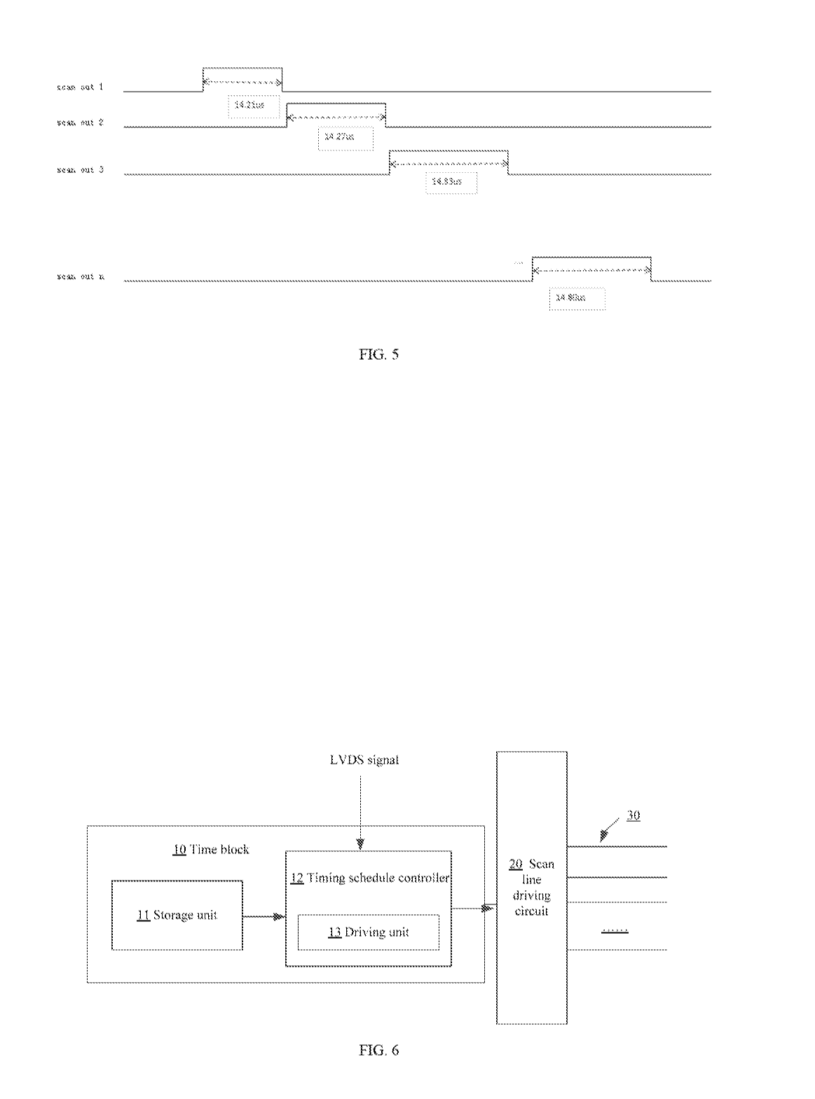

As shown in FIG. 6, the present disclosure provides the driving circuit of the display panel and the method for driving the display panel. The driving circuit of the display panel comprises the scan lines 30 and a scan line driving circuit 20 connected to the scan lines 30. A time block 10 comprises a timing schedule controller 12 and a storage unit 11, and the timing schedule controller 12 comprises a driving unit 13 that increases the driving time of the scan lines row by row.

The driving unit 13 reads the difference value between the driving times of two adjacent rows of the scan lines from the storage unit 11 to generate a driving signal, and sends the driving signal to the scan line driving circuit 20.

The driving time of the first row of the scan lines is regarded as T, the number of the scan lines is regarded as N, the vertical blanking time between two adjacent frame pictures is regarded as Tl, and the sum of the driving time of all scan lines is regarded as Tm, thus, the difference value between Tm and T*N is less than or equal to Tl.

It should be understood that the difference value between the driving times of two adjacent rows of scan lines may not be the same this time, the driving unit 13 is not used, the timing schedule controller 12 reads the driving time of each row of scan line from the storage unit 11 to generate the driving signal, and sends the driving signal to the scan line driving circuit 20.

The storage unit employs an electrically erasable programmable read-only memory (EEPROM), and other storage device also can be used, such as a flash memory, a read-only memory (ROM).

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A method for driving a display panel, comprising:
driving scan lines of the display panel row by row;
wherein in a time period of displaying one frame, a driving time of at least one row of the scan line is greater than a driving time of a first row of the scan lines, and a sum of driving times of all scan lines is less than or equal to a display time of a single frame picture.

2. The method for driving the display panel of claim 1, wherein the driving time of the first row of scan lines is regarded as T, a number of the scan lines is regarded as N, a vertical blanking time between two adjacent frame pictures is regarded as Tl, and the sum of driving times of all scan lines is regarded as Tm, a difference value between Tm and T*N is less than or equal to Tl.

3. The method for driving the display panel of claim 1, wherein in the time period of displaying one frame, a driving time of a next row of the scan lines is greater than a driving time of a previous row of the scan lines.

4. The method for driving the display panel of claim 3, wherein in the time period of displaying one frame, a difference value between the driving times of two adjacent rows of scan lines is same or gradually increases.

5. The method for driving the display panel of claim 1, wherein the scan lines are divided into a plurality of groups, and the scan lines of each of the groups comprises at least one row of scan lines; a driving time of a next group of scan lines is greater than a driving time of a previous group of scan lines.

6. The method for driving a display panel of claim 5, wherein the driving times of the scan lines in each of the groups are same.

7. The method for driving a display panel of claim 5, wherein in the time period of displaying one frame, a difference value between the driving times of two adjacent groups of the scan lines is same.

8. A driving circuit of a display panel, comprising:
scan lines; and
a time block that controls a driving sequence of the scan lines;
wherein the scan lines are connected to the time block, and the time block drives the scan lines row by row;
in a time period of displaying one frame, a driving time of at least one row of scan lines is greater than a driving time of a first row of scan lines, and a sum of driving times of all scan lines is less than or equal to display time of single frame picture.

9. The driving circuit of the display panel of claim 8, further comprising:
a scan line driving circuit connected to the scan lines;
wherein the time block comprises a timing schedule controller coupled to the scan line driving circuit, and a storage unit coupled to the timing schedule controller; the timing schedule controller reads a driving time of each row of the scan lines from the storage unit to generate a driving signal, and sends the driving signal to the scan line driving circuit.

10. The driving circuit of the display panel of claim 8, further comprising:
a scan line driving circuit connected to the scan lines;
wherein the time block comprises a timing schedule controller and a storage unit, and the timing schedule controller comprises a driving unit that increases the driving time of the scan lines row by row; the driving unit reads a difference value between the driving times of two adjacent rows of the scan lines from the storage unit to generate a driving signal, and sends the driving signal to the scan line driving circuit.
